(19) United States
(12) Patent Application Publication
(10) Pub. No.: US 2001/0004412 A1
(43) Pub. Date: Jun. 21, 2001

(54) Automatic apparatus for assembling fiber jumper

(75) Inventors: Shih Chen Chou, Miaoli (TW); Winyann Jang, Taichung (TW)

Correspondence Address: DARBY & DARBY P.C., 805 Third Avenue, New York, NY, 10022, US

(73) Assignee: U-Conn Technology Inc.

(21) Appl. No.: 09/725,436

(22) Filed: Nov. 29, 2000

(30) Foreign Application Priority Data
Dec. 20, 1999 (TW) 88221665

(51) Int. Cl. G02B 6/36

(52) U.S. Cl. 385/80; 156/166

(57) ABSTRACT

An automatic apparatus for assembling an optical fiber cable, a pre-assembled element and a sleeve. The automatic apparatus includes a glue-injecting mechanism, a feeding mechanism, a forging press, a movable stand, a clamping and rotating mechanism and a robot. Glue is injected into the pre-assembled element by the glue-injecting mechanism. Then, the robot conveys the pre-assembled element from the glue-injecting mechanism to the clamping and rotating mechanism. The optical fiber cable and sleeve are supported by the movable stand. The stand is moved toward the pre-assembled element so that the optical fiber cable enters the pre-assembled element. Then, the optical fiber cable is further pushed into the pre-assembled element by the feeding mechanism. Then, the pre-assembled element is covered with the sleeve by the feeding mechanism. Then, the sleeve is pressed by the forging press so that the sleeve is deformed to engage the pre-assembled element.

### BACKGROUND OF THE INVENTION

1. Field of the Invention

The present invention relates in general to an automatic apparatus for assembling fiber jumpers.

2. Description of the Related Art

Fiber jumpers are widely applied to communication for transmitting optical signals. A fiber jumper has an optical fiber cable and two connectors connected to both ends of the optical fiber cable. Referring to FIG. 1A, an optical fiber cable 1 has, from out to in, a plastic outer cover 16, celvars 14, a resin layer 12 and a core 10. Also referring to FIG. 1B, a connector of a fiber jumper includes an alignment ferrule 23, a spring 21, a rear tubular housing 22 and a sleeve 24, wherein the alignment ferrule 23, the spring 21 and the rear tubular housing 22 can be pre-assembled as an element 20. Furthermore, the alignment ferrule 23 has a first hole 25 and a second hole 26 inside. The inner diameter of the first hole 25 is smaller than that of the second hole 26.

A fiber jumper is assembled in the following way: AB glue is applied into the second hole 26. Then, the optical fiber cable 1 is inserted into the pre-assembled element 20 as shown in FIG. 1C, wherein the core 10 is inside the first hole 25, the resin layer 12 is inside the second hole 26 and is fixed by the AB glue, and the celvars 14 cover the rear tubular housing 22. Then, the sleeve 24 is assembled therewith, with the celvars 14 clamped between the rear tubular housing 22 and the sleeve 24.

Currently, assembling fiber jumpers is practiced totally by manual labor. That is inefficient and expensive due to high labor costs.

### SUMMARY OF THE INVENTION

An object of the present invention is to provide an automatic apparatus for assembling fiber jumpers that improves the efficiency of manufacturing operations and reduces the percentage of total cost represented by labor costs.

The automatic apparatus of the present invention includes a glue-injecting mechanism, a feeding mechanism, a forging press, a movable stand, a clamping and rotating mechanism and a robot. Glue is injected into the pre-assembled element by the glue-injecting mechanism. Then, the robot conveys the pre-assembled element from the glue-injecting mechanism to the clamping and rotating mechanism. The optical fiber cable and sleeve are supported by the movable stand. The stand is moved toward the pre-assembled element so that the optical fiber cable enters the pre-assembled element. Then, the optical fiber cable is further pushed into the pre-assembled element by the feeding mechanism. Then, the pre-assembled element is covered with the sleeve by the feeding mechanism. Then, the sleeve is pressed by the forging press so that the sleeve is deformed to engage the pre-assembled element.

### BRIEF DESCRIPTION OF THE DRAWINGS

The present invention can be more fully understood by reading the subsequent detailed description and examples with references made to the accompanying drawings, wherein:

FIG. 1A depicts an optical fiber cable;

FIG. 1B is a sectional view of a pre-assembled element and a sleeve of an optical fiber connector;

FIG. 1C depicts the optical fiber cable and the pre-assembled element assembled together;

FIG. 1D depicts the optical fiber cable, the pre-assembled element and the sleeve assembled together as a fiber jumper;

FIG. 2 is a perspective diagram of an automatic apparatus of the present invention;

FIG. 3A is a left side view of the glue-injecting mechanism 30 of FIG. 2;

FIG. 3B is a front view of the glue-injecting mechanism 30 of FIG. 2;

FIG. 4 is a front view of the robot of FIG. 2;

FIG. 5A is a front view of the clamping and rotating mechanism of FIG. 2;

FIG. 5B is a perspective diagram of the three-jaw air cylinder of FIG. 5A;

FIG. 6 is a front view of the movable stand of FIG. 2;

FIG. 7A is a perspective diagram of the gripper of the feeding mechanism of FIG. 2;

FIG. 7B depicts one of the jaws of the gripper of FIG. 7A;

FIG. 8A is a front view of FIG. 2;

FIG. 8B is a perspective diagram of the forging press of FIG. 2;

FIG. 9 depicts the movable stand of the automatic apparatus of the present invention, with the optical fiber cable and sleeve mounted thereon; and

FIG. 10 depicts the rotatable disk of the automatic apparatus of the present invention, with pre-assembled elements mounted thereon.

### DETAILED DESCRIPTION OF THE PREFERRED EMBODIMENT

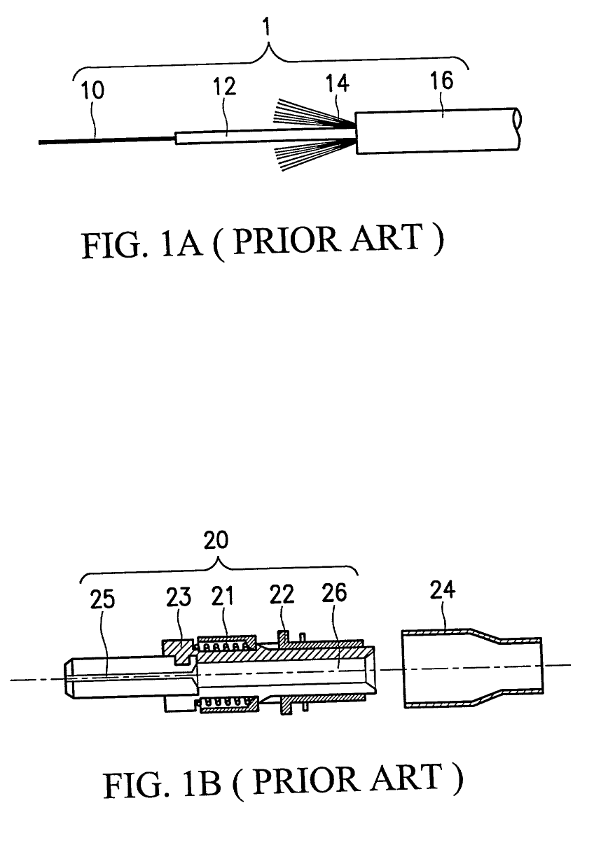

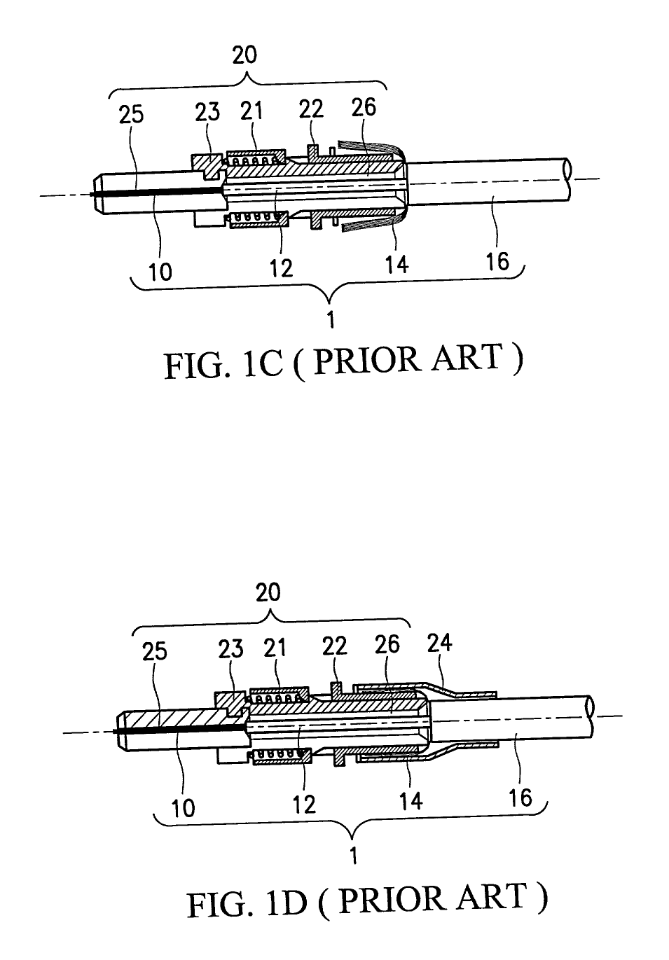

Referring to FIG. 2, an automatic apparatus of the present invention includes a glue-injecting mechanism 30, a control mechanism 40, a robot 50, a clamping and rotating mechanism 60, a movable stand 70, a feeding mechanism 80 and a forging press 90. The automatic apparatus is used for assembling the optical fiber 1 (FIG. 1A), the pre-assembled element 20 and sleeve 24 (FIG. 1B) together as a fiber jumper (FIG. 1D). The assembling operation is carried out on a worktable 100. The above-mentioned mechanisms 30, 40, 50, 60, 70, 80, 90 are described in detail as follows:

(A) Glue-injecting Mechanism:

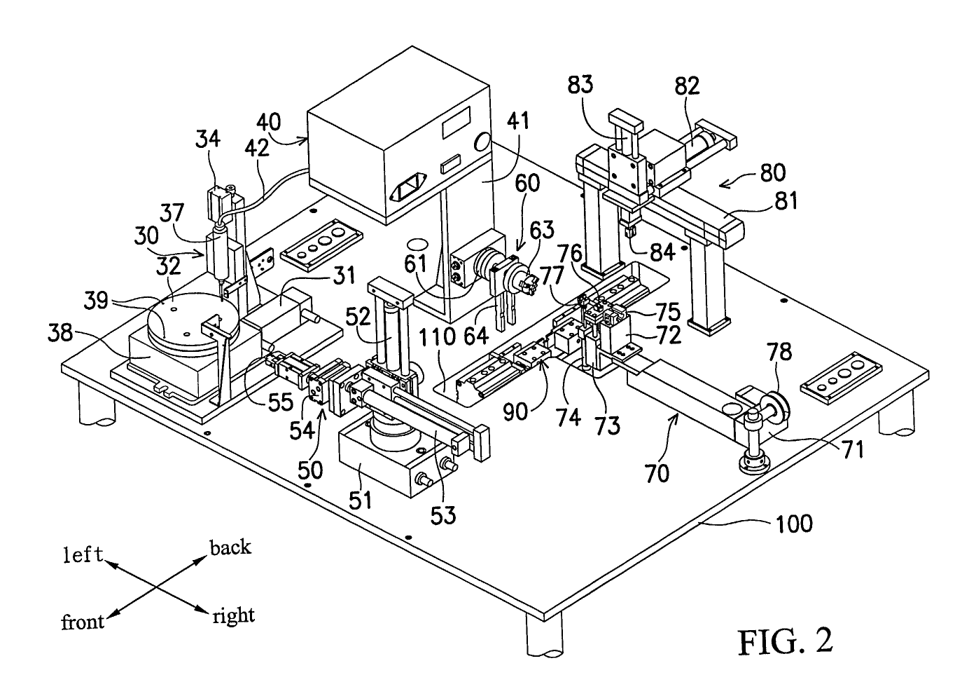

Refer to FIG. 2, for clear description, the directions of front, back, left and right are indicated in FIG. 2. FIG. 3A is a left side view of the glue-injecting mechanism 30 of FIG. 2 and FIG. 3B is a front view of the glue-injecting mechanism 30 of FIG. 2. A vertical air cylinder 34 is fixed to a support 33. An output shaft of the air cylinder 34 is connected to a syringe 37 via a floating joint 35 and a connecting plate 36 for vertically moving the syringe 37. AB glue is put in the syringe 37, while the syringe 37 is connected to the control mechanism 40 via a compressed air pipe 42. The control mechanism 40 is used for controlling the air pressure in the air pipe 42 to release a proper quantity of AB glue from the syringe 37. Under the syringe 37 is a rotatable disk 32. A plurality of holes 39 are provided on the disk 32 for receiving the above-mentioned pre-assembled elements 20. A rotating mechanism 38 is provided under the rotatable disk 32, while a horizontal air cylinder 31 is provided beside the rotating mechanism 38. The rotating mechanism 38 has transmission gears and racks (not shown) inside for transmitting power from the horizontal air cylinder 31 (linear motion) to the rotatable disk (rotation).

(B) Robot:

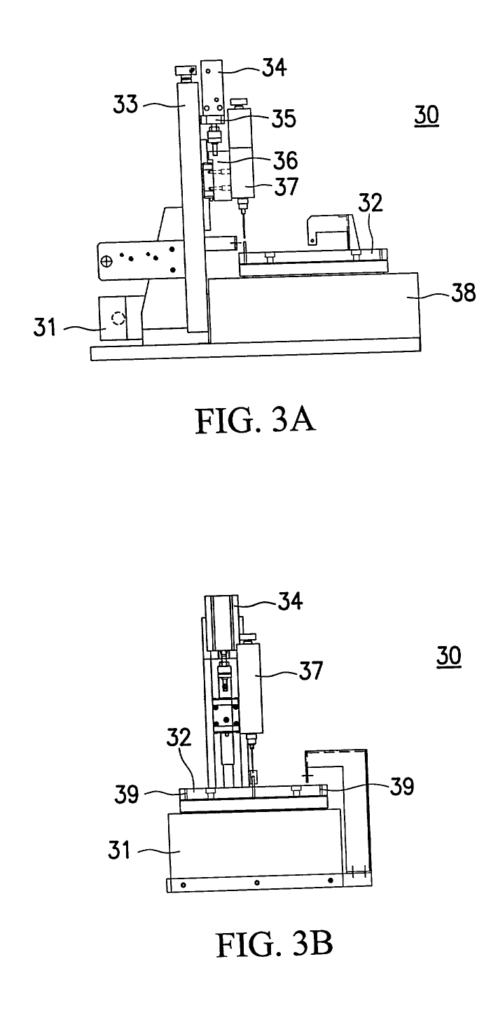

Please refer to FIGS. 2 and 4, wherein FIG. 4 is a front view of the robot of FIG. 2. The robot 50 has a revolving air cylinder 51, a vertical air cylinder 52, a horizontal air cylinder 53 and a revolving air cylinder 54 for rotating and moving a gripper 55 at the end of the robot in three-dimensional space. In detail, the revolving air cylinder 51 drives the jaw to rotate in directions b, b′. The vertical air cylinder 52 drives the gripper 55 to move in directions d, d′. The horizontal air cylinder 53 drives the gripper 55 to move in direction c, c′. The revolving air cylinder 54 drives the gripper 55 to rotate in direction e, e′.

(C) Clamping and Rotating Mechanism:

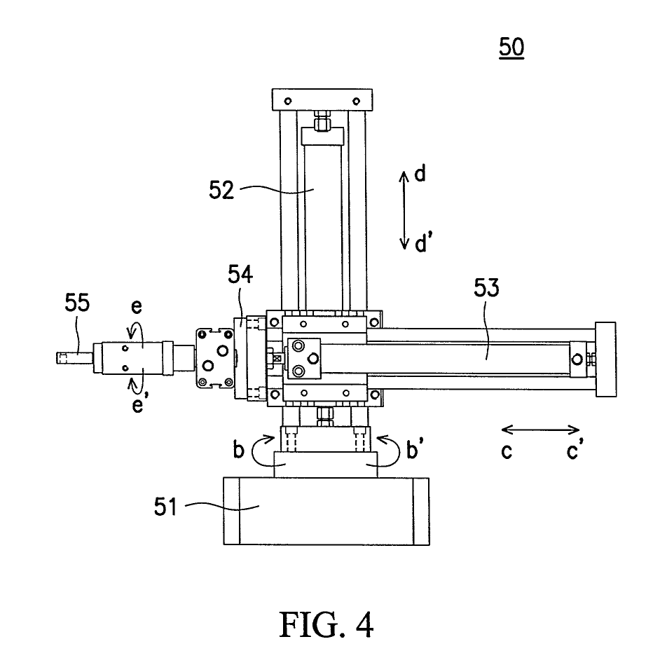

Please refer to FIGS. 2 and 5A, wherein FIG. 5A is a front view of the clamping and rotating mechanism of FIG. 2. The clamping and rotating mechanism 60 has a revolving air cylinder 61 fixed to the support 41 which supports the glue-injecting mechanism 40. An output shaft 62 of the revolving air cylinder 61 is connected to a three-jaw air cylinder 63, while a support 64 supports the output shaft 62 of the revolving air cylinder 61 to prevent the output shaft 62 from over-bending under the lateral load of the three-jaw air cylinder 63. FIG. 5B is a perspective diagram of the air cylinder 63, wherein a hole 634 is provided at the center of the air cylinder 63 for receiving the pre-assembled element 20. Three jaws 631, 632, 633 are provided around the hole 634 and are movable in directions f, f′, f″ to clamp the pre-assembled element 20. Furthermore, another hole 635 is provided beside the jaws 631, 633 for blowing air out therefrom.

(D) Movable Stand:

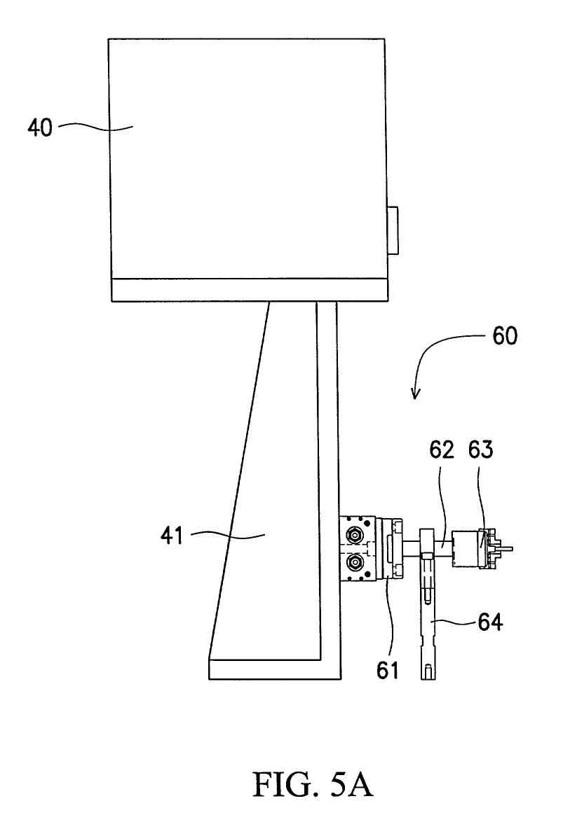

Please refer to FIGS. 2 and 6, wherein FIG. 6 is a front view of the movable stand of FIG. 2. The movable stand 70 includes a pulley 78, a servo slide rail 71, three vertical air cylinders 72, 73, 74, two L-shaped connecting plates 791, 792, a holder 75, a sleeve support 76 and a vacuum cable support 77. The servo slide rail 71 is provided on the left side of the pulley 78. The vertical air cylinders 72, 73, 74 are connected to an end of the servo slide rail 71 via the L-shaped connecting plates 791, 792, wherein the output motion of the servo slide rail 71 is linear in the right and left directions in FIG. 2. The holder 75 is fixed to the output end of the air cylinder 72 so that the air cylinder 72 drives the holder 75 to operate (grasp or release something). The sleeve support 76 is fixed to the output shaft of the air cylinder 73 so that the air cylinder 73 can drive the sleeve support 76 to vertically move (up and down). The cable support 77 is fixed to the output shaft of the air cylinder 74, while the air cylinder 74 drives the vacuum cable support 77 to move up and down. Furthermore, the sleeve support 76 has a first portion 761 and a second portion 762 spaced apart from each other for supporting the sleeve 24 of the connector.

(E) Feeding Mechanism:

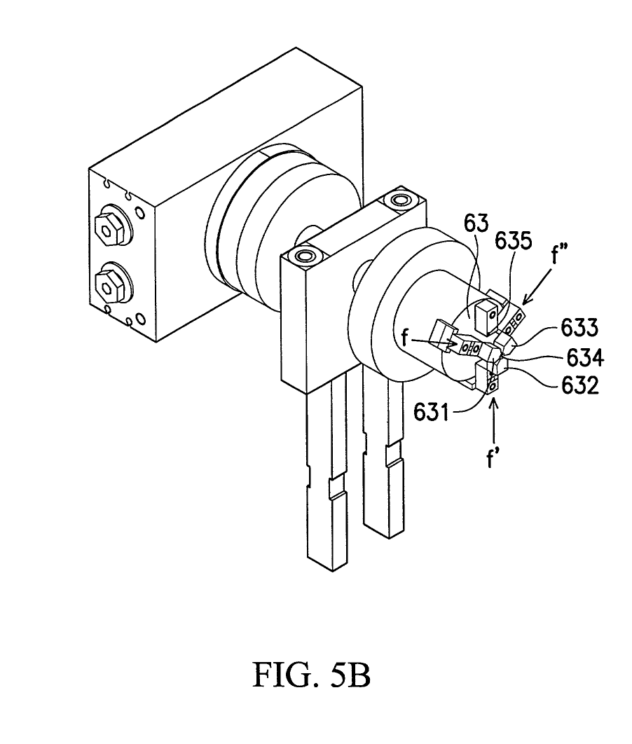

Referring to FIG. 2, the feeding mechanism 80 includes a servo slide rail 81, a horizontal air cylinder 82 and a vertical air cylinder 83, each of which linearly moves so that the gripper 84 at the end of the feeding mechanism 80 can be moved in 3-dimensions. Further refer to FIG. 7A, the gripper 84 of the feeding mechanism 80 has two symmetrical jaws 842. The two jaws 842 are moved close to each other while grasping an object, and are moved away from each other while releasing the object. FIG. 7B depicts one of the jaws, wherein an opening 8424 is provided on the jaw 842 to create two clamping portions 8421, 8422. A rubber block 8423 is attached to the clamping portion 8421 for physically contacting the optical fiber cable. Also, a recess 8425 is formed on the other clamping portion 8422. The clamping portion 8422 is used to physically contact the sleeve 24 of the optical fiber connector, with the sleeve 24 in the recess 8425.

(F) Forging Press:

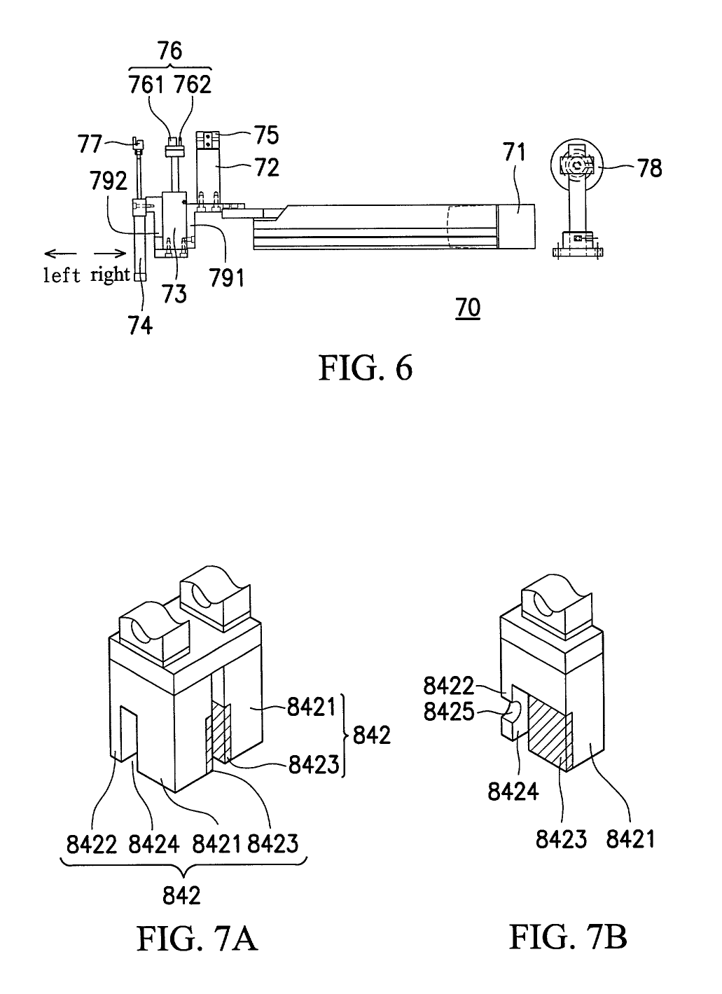

Referring to FIG. 2, a cavity 110 is provided on the worktable 100 for receiving the forging press 90. Further referring to FIG. 8A, a vertical air cylinder 91 is provided under the worktable 100 and is connected to the forging press 90 via a bottom plate 92. Then, the forging press 90 can be moved up and down by the vertical air cylinder 91. Also referring to FIG. 8B, the forging press 90 has a pair of horizontal air cylinders 93 and a pair of pressing blocks 94 connected to the air cylinders 93. In operation, the pressing blocks 94 are moved close to each other to compress an object disposed therebetween.

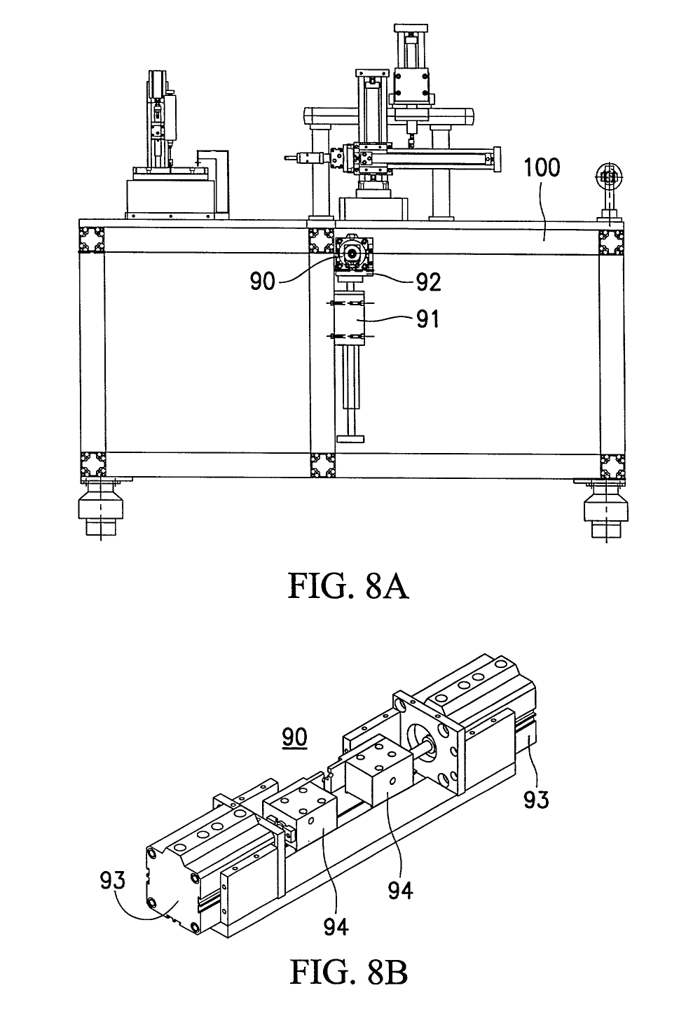

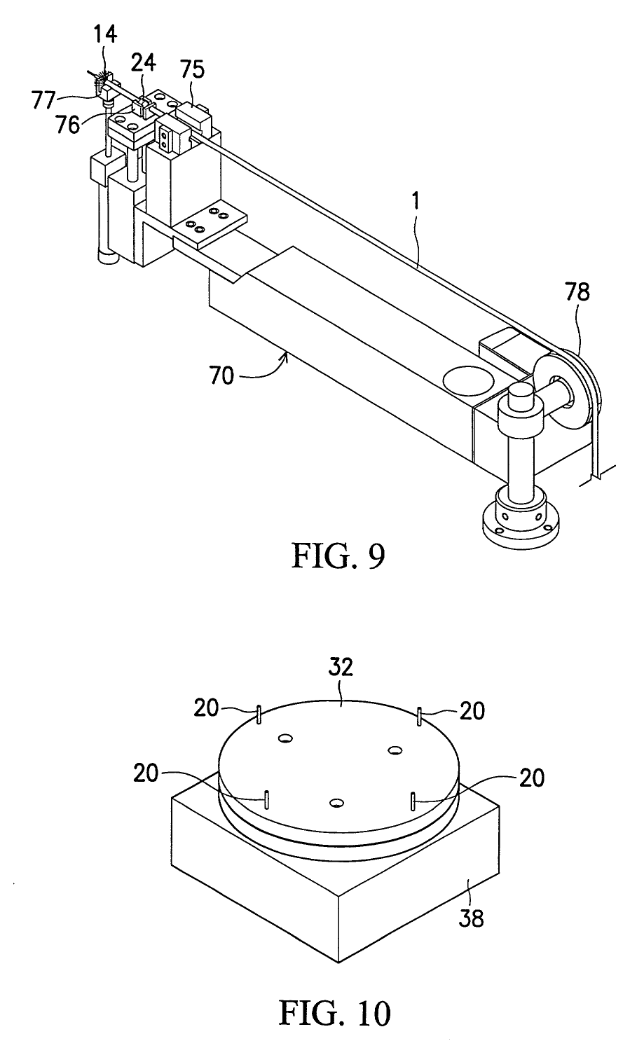

Now, the operation of the automatic apparatus of the present invention is described. The optical fiber cable 1, the pre-assembled element 20 and the sleeve 24 are mounted on the automatic apparatus before the operation proceeds: Referring to FIG. 9, the optical fiber cable 1 is led through the sleeve 24. Then, the sleeve 24 is disposed on the sleeve support 76, and the optical fiber cable 1 is mounted on the movable stand 70, simultaneously supported by the vacuum cable support 77 and pulley 78 and held by the holder 75. The vacuum cable support 77 attracts the optical fiber cable 1 by vacuum pressure to keep the optical fiber cable 1 straight on the movable stand 70. Such an arrangement ensures that the optical fiber cable 1 enters the second hole 26 of the pre-assembled element 20 in the later automatic assembling process. Furthermore, a plurality of pre-assembled elements 20 are inserted into the holes 39 of the rotatable disk 32 as shown in FIG. 10.

The steps of assembling the fiber jumpers by the automatic apparatus of the present invention are described as follows:

(1) The glue-injecting mechanism 70 operates first off. The syringe 37 is driven by the vertical air cylinder 34 to move downward. Then, the control mechanism 40 controls the air pressure in the compressed air pipe 42 to inject a proper quantity of AB glue from the syringe 37 into the second hole 26 of the pre-assembled element 20. Then, the vertical air cylinder 34 raises the syringe 37 back to its original position. Then, the rotatable disk 32 is driven by the horizontal air cylinder 31 so that the pre-assembled element 20 on the disk 32 is moved to the position close to the robot 50.

(2) The robot 50 takes the pre-assembled element 20 out from the rotatable disk 32 and moves the pre-assembled element 20 to the clamping and rotating mechanism 60. The pre-assembled element 20 is firmly held by the three-jaw air cylinder 63 of the clamping and rotating mechanism 60. Then, the robot 50 moves back to its original position.

(3) The movable stand 70 moves toward the left in FIG. 2 so that the core 10 of the optical fiber cable 1 goes into the second hole 26 of the pre-assembled element 20. Meanwhile, the three-jaw air cylinder 63 is rotated by the revolving air cylinder 61 for facilitating the core 10 to enter the second hole 26 of the pre-assembled element 20. When the core 10 entirely enters the second hole 26, the three-jaw air cylinder 63 stops rotating.

(4) The gripper 84 is moved to hold the optical fiber cable 1 at the position between the sleeve support 76 and the vacuum cable support 77, with the rubber blocks 8423 thereof physically contacting the optical fiber cable 1. Then, the vacuum cable support 77 is lowered to separate from the optical fiber cable 1 and the holder 75 of the movable stand 70 releases the optical fiber cable 1.

(5) The gripper 84 of the feeding mechanism 80 is moved toward the left in FIG. 2, pushing the core 10 of optical fiber cable 1 into the first hole 25 of the pre-assembled element 20. Meanwhile, the three-jaw air cylinder 63 is rotated by the revolving air cylinder 61 for facilitating the core 10 to enter the first hole 25 of the pre-assembled element 20. The gripper 84 of the feeding mechanism 80 pushes the core 10 three times. On the third time, air is blown out from the hole 635 of the three-jaw air cylinder 63 to spread out the celvars 14 of the optical fiber cable 1. Such an arrangement keeps the celvars 14 from entering the second hole 26 together with the resin layer 12. When the core 10 entirely enters the first hole 25, the three-jaw air cylinder 63 stops rotating and blowing.

(6) The gripper 84 of the feeding mechanism 80 releases the optical fiber cable 1 and moves to sleeve support 76, to hold the sleeve 24 with the clamping portions 8422 thereof (rather than with the rubber blocks 8423 of the clamping portions 8424). Wherein the sleeve 24 is contained in the recesses 8425 of the clamping portions 8422. Then, the sleeve support 76 is lowered to separate from the sleeve 24. Then, the gripper 84 of the feeding mechanism 80 is moved toward the left in FIG. 2, pushing the sleeve 24 to cover the celvars 14 and the rear tubular housing 22. Then, the gripper 84 releases the sleeve 24 and moves back to its original position.

(7) The forging press 90 is driven by the vertical air cylinder 91 to rise out of the cavity 110 on the worktable 100, until the sleeve 24 is exactly between the pressing blocks 94 of the forging press 90. Then, the pressing blocks 94 are driven by the horizontal air cylinder 93 to press the sleeve 24 therebetween. The sleeve 24 is deformed to engage the pre-assembled element 20. Then, the pressing blocks 94 are driven to separate from each other. The forging press 90 is lowered back to the inside of the cavity 110, and the vacuum cable support 77 is raised to support the optical fiber cable 1.

From the above, it is understood that the present invention provides an automatic apparatus for assembling fiber jumpers that improves the efficiency of manufacturing operations and reduces the percentage of total cost represented by labor costs.

Furthermore, what is introduced (FIG. 1B) is an SC-type connector. However, it is understood that FC-type and ST-type connectors are also suitable for the automatic apparatus of the present invention, wherein the assembling operation is carried out in the same way but the jaws 631, 632, 633, the sleeve support 76, the gripper 84 and the pressing blocks 94 need to be changed.

While the invention has been described by way of example and in terms of the preferred embodiment, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An automatic apparatus for assembling an optical fiber cable, a pre-assembled element and a sleeve together, the automatic apparatus including:
a glue-injecting mechanism for injecting glue into the pre-assembled element;
a feeding mechanism for inserting the optical fiber cable into the pre-assembled element and then covering the pre-assembled element with the sleeve; and
a forging press for pressing the sleeve so that the sleeve is deformed to engage the pre-assembled element.

2. An automatic apparatus as claimed in claim 1, wherein the glue-injecting mechanism includes a syringe for receiving the glue and releasing the glue.

3. An automatic apparatus as claimed in claim 2, further including a control mechanism connected to the syringe for controlling the syringe to release a proper quantity of glue.

4. An automatic apparatus as claimed in claim 1, further including a stand for supporting the optical fiber cable and the sleeve.

5. An automatic apparatus as claimed in claim 4, wherein the stand is movable toward the pre-assembled element to push the optical fiber cable into the pre-assembled element, and then the feeding mechanism inserts the optical fiber cable further into the pre-assembled element.

6. An automatic apparatus as claimed in claim 5, further including a clamping and rotating mechanism for holding the pre-assembled element, and for rotating the pre-assembled element when the stand is moved toward the pre-assembled element.

7. An automatic apparatus as claimed in claim 1, further including a clamping and rotating mechanism for holding the pre-assembled element, and for rotating the pre-assembled element when the optical fiber cable is inserted into the pre-assembled element by the feeding mechanism.

8. An automatic apparatus as claimed in claim 7, wherein the optical fiber cable has celvars, and the clamping and rotating mechanism blows at the optical fiber cable to spread out the celvars, thereby keeping the celvars from entering the pre-assembled element when the optical fiber cable is inserted into the pre-assembled element.

9. An automatic apparatus as claimed in claim 7, further including a robot for conveying the pre-assembled element from the glue-injecting mechanism to the clamping and rotating mechanism.

10. An automatic apparatus as claimed in claim 1, wherein the feeding mechanism includes two symmetrical jaws for grasping and inserting the optical fiber cable into the pre-assembled element and for grasping and putting the pre-assembled element into the sleeve.

11. An automatic apparatus as claimed in claim 10, wherein each of the jaws has a first clamping portion, a rubber block connected to the first clamping portion for physically contacting the optical fiber cable, and a second clamping portion spaced apart from the first clamping portion for physically contacting the sleeve.

12. An automatic apparatus as claimed in claim 10, wherein a recess is formed on the second clamping portion for receiving the sleeve when the second clamping portion physically contacts the sleeve.
